(19) United States
(12) Patent Application Publication
(10) Pub. No.: US 2007/0186182 A1
(43) Pub. Date: Aug. 9, 2007

(54) Progressive loading

(75) Inventor: Scott Schiller, Sunnyvale, CA (US)

Correspondence Address: MORRISON & FOERSTER LLP, 425 MARKET STREET, SAN FRANCISCO, CA, 94105-2482, US

(73) Assignee: Yahoo! Inc., Sunnyvale, CA (US)

(21) Appl. No.: 11/364,992

(22) Filed: Feb. 28, 2006

Related U.S. Application Data
(60) Provisional application No. 60/765,990, filed on Feb. 6, 2006.

(51) Int. Cl. G06F 3/048

(52) U.S. Cl. 715/781

(57) ABSTRACT

A system and method for dynamic loading of data elements included in a page are disclosed herein. The data elements to be positioned within a portion of the page currently viewable in a browser window are loaded. The data elements to be positioned outside of the portion of the page currently viewable at the browser window are not loaded. Changes to the viewable portion of the page are monitored to load additional data elements on an as-needed basis.

### CROSS-REFERENCE TO RELATED APPLICATIONS

This application claims priority to U.S. Provisional Patent Application No. 60/765,990 filed Feb. 6, 2006, the contents of which are incorporated herein by reference in its entirety.

### BACKGROUND OF THE INVENTION

The present invention relates to a computer-implemented system for image access. More particularly, the present invention relates to dynamic control of loading of images.

With the increasing popularity of digital cameras, digital camcorders, and other still image and/or video capturing devices, a person can rapidly have a large number of photos and/or videos (collectively referred to as images). The number of images can be further increased by clip art or other types of images that a person obtains from existing electronic documents. Sharing of images between persons can further add to the total number of images in a person's collection.

Although the images can be stored in electronic form, the size of each image is relatively large and a person may not have enough storage capability. A digital photo can be several MB or larger in size. Several hundred such photos can easily fill up a hard drive and the person may be required to upgrade his computer or purchase peripheral storage devices to accommodate his ever-expanding image collection. As the number of images increase, categorizing and the ability to access a particular image become issues. Also, with the images stored at a local storage device, remote access is not possible.

Due to these shortcomings, on-line storage of images is becoming common. The images are stored on someone else's computer/server and accessed via the Internet or a network (e.g., local area network or wide area network). There are websites that are dedicated to serving as on-line albums for a person's images. The person would access the website using a uniform resource locator (URL) and by entering a unique login and password. The person can then add, delete, and manipulate images (e.g., create multiple albums, provide image names, send images to friends and family, provide shared access to certain images). Alternatively, websites may serve as a general repository (e.g., a posting website) and anyone using the correct URL would have access to the images.

Currently, when a particular URL or web page is requested using a browser application (e.g., Internet Explorer, Firefox, etc.), the content of that web page is automatically loaded in its entirety (absent firewalls or other mechanisms that prevent loading) for presentment on the browser window. This is the case even if only a portion of the web page is viewable on the browser window at any given time. For example, the web page includes a list or list in a grid layout requires scrolling to view in its entirety. For web pages containing images, especially a large number of images, this can mean a considerable amount of time to fully load the web page. During this loading process, most or all of the bandwidth for data transmission may be occupied and the user may not be able to take action on that web page till loading is complete. The greater the length of a web page, data size of images, and/or number of images, the longer it takes to fully load the web page onto the browser window. Depending on the bandwidth for data transmission, this can further increase the time for loading. For example, the bandwidth associated with a dial-up connection would be smaller than the bandwidth associated with a DSL connection.

Thus, it would be beneficial to more efficiently use bandwidth for data transmission. It would be beneficial to dynamically, progressively, or “smart” load images only as the user needs at a given time. It would be beneficial to provide faster completion of loading of a web page based on the viewable portion of the web page on a browser application window. It would be beneficial to provide selective loading of relatively large sized data items in a web page in response to user actions so as to improve user's experience and interaction with the web page.

### BRIEF SUMMARY OF THE INVENTION

One aspect of the invention relates to a method for progressively constructing a web page. The method includes determining the portion of the web page viewable at a user interface (UI) window. The determined portion of the web page comprises a first portion of the web page. The method also includes identifying data items that will be at least partially viewable within the first portion of the web page. The data items are to be positioned within the first portion of the web page in accordance with a grid template. The method also includes loading the identified data items, and providing the first portion of the web page at the UI window using the loaded data items. The data items associated with the portion of the web page not presently viewable at the UI window are not loaded.

Another aspect of the invention includes a computer program product comprising code for dynamically loading elements to a client device. The computer program product includes code operable to track which elements included in a page will be visible at the client device. The computer program product further includes code operable to dynamically load the tracked elements for presentation at the client device. The page includes a plurality of elements positioned in accordance with a grid layout. The elements that will not be visible at the client device or the elements previously loaded in a current session with the client device are not loaded.

Still another aspect of the invention includes a system for constructing a partial page on an as-needed basis. The system includes logic operable to determine first objects that will be at least partially positioned within a first viewable segment of a page. The first viewable segment of the page comprises a segment of the page that is currently requested at a client site. The system also includes logic operable to download the first objects to present the first viewable segment of the page at the client site. At least one of the first objects is positioned within the first viewable segment of the page in accordance with a grid layout. The system further includes logic operable to download second objects that will be at least partially positioned within a second viewable segment of the page when the segment of the page that is currently requested changes from the first viewable segment of the page to the second viewable segment of the page. The first and second viewable segments of the page comprise different segments of the page relative to each other. At least one of the first and second objects comprises different objects relative to each other.

Another aspect of the invention relates to a server system in communication with a plurality of clients. The server system comprises logic operable to receive a first request for a page from a client, and load at least a first data item included in the page that will be at least partially visible within a viewing window of the page at the client. The server system also includes logic operable to provide the page including the loaded first data item to the client. The system also includes logic operable to wait to load at least a second data item included in the page, the second data item positioned outside the viewing window of the page at the client, until a second request from the client requests the second data item be at least partially visible within the viewing window of the page at the client. Data items included in the page are positioned according to a dynamic grid template and the data items include the first and second data items.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined by the claims attached hereto.

### BRIEF DESCRIPTION OF THE DRAWINGS

The exemplary embodiments will become more fully understood from the following detailed description, taken in conjunction with the accompanying drawings, wherein the reference numeral denote similar elements, in which:

FIG. 1 is a block diagram of one embodiment of a progressive loading system.

FIG. 2 illustrates different sized browser windows and implementation of a fluid grid template.

FIG. 3 is a flow diagram of one embodiment of a progressive loading function implemented in the system of FIG. 1.

FIGS. 4-9 are screenshots of a browser window implementing the progressive loading function of FIG. 3.

FIG. 10 is a flow diagram of one embodiment of a refresh progressive loading function implemented in the system of FIG. 1.

FIG. 11 is a flow diagram of one embodiment of a determine on-screen image function implemented in the system of FIG. 1.

FIG. 12 is a flow diagram of one embodiment of a queue and load function implemented in the system of FIG. 1.

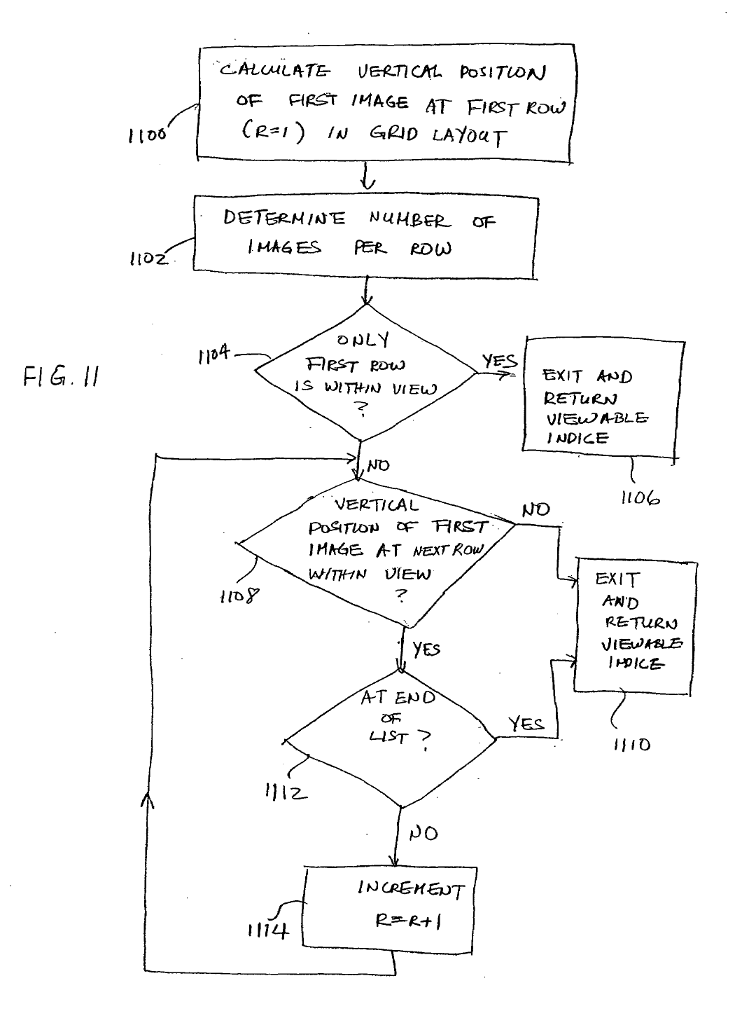

In the drawings, to easily identify the discussion of any particular element or art, the most significant digit or digits in a reference number refer to the figure number in which that element is first introduced (e.g., element 1104 is first introduced and discussed with respect to FIG. 11).

The headings provided herein are for convenience only and do not necessarily affect the scope or meaning of the claimed invention.

### DETAILED DESCRIPTION OF THE PREFERRED EMBODIMENTS

Described in detail below is a system and method for providing dynamic, progressive, or “smart” loading of items included in a web page based on the viewable portion of the web page on a browser window. In one embodiment, downloading of items included in the web page for presentment on the browser window is controlled. User actions such as a request for a new web page, resizing of the browser window, or scrolling of the web page at the browser window are monitored to provide the progressive loading functionality. If it is likely that there is insufficient time to load data items before such data items become out-of-view for the user, then minimal or partial loading of the data items occur for user usefulness with minimal bandwidth usage. The progressive loading functionality is accessed intermittently or on an as-needed basis to minimize resource usage. Each time the presentment of the web page at the browser window changes (due to user action), the progressive loading functionality again provides loading of data items within the web page based on the viewable portion of the web page on the browser window.

Accordingly, a user observes a virtual increase in download speed since he/she does not need to wait for the entire web page to load. The user can take quicker action at the web page portion viewable on the browser window. The progressive loading is not based on generic anticipation or likelihood of the user's actions. Rather, it is based on the user's actual actions to the browser. Data items that are likely to appear in a grid layout (or two-dimensional tiles) at the web page benefit from the progressive loading functionality. The data items can be, but are not limited to, text, image, graphics, audio, files, multi-media content, icons, advertisements, or thumbnails representative of text, image, graphics, audio, files, multi-media content, or advertisements.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention.

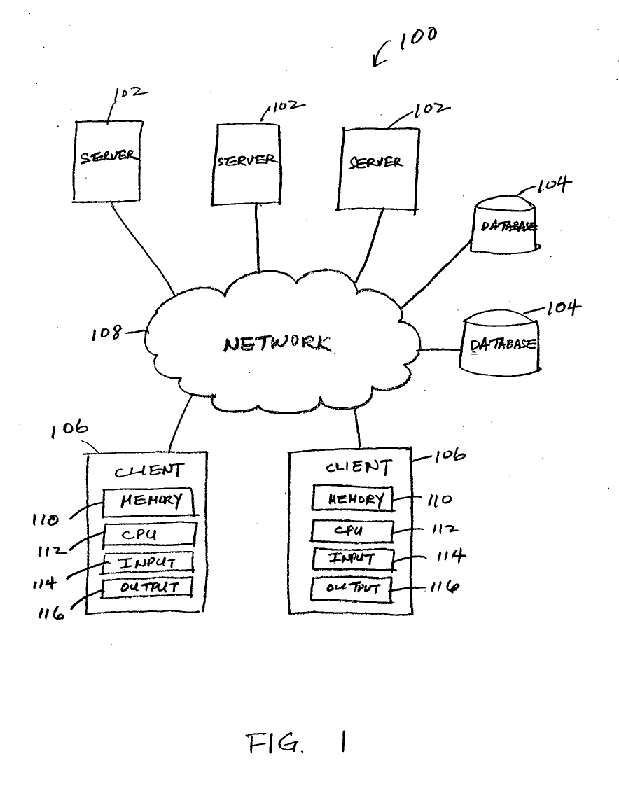

Referring to FIG. 1, a block diagram of one embodiment of a progressive loading system 100 is shown. The system 100 includes each of a plurality of servers 102, a plurality of databases 104, and a plurality of clients 106 in communication with a network 108.

The servers 102 are host servers operable to provide content to clients 106 via the network 108. One or more of the servers 102 hosts web sites and include the progressive loading functions. The databases 104 are operable to store data provided by the servers 102 and/or clients 106. The databases 104 can communicate with the servers 102 or clients 106 via the network 108. The databases 104 can store data items included in the web pages, such as photos.

Alternatively, the servers 102 may include the databases 104, processors, switches, routers, interfaces, and other components and modules. Each of the servers 102 may comprise one or more servers, or may be combined into a fewer number of servers than shown, depending on computational and/or distributed computing requirements. The servers 102 may be located at different locations relative to each other. The databases 104 may also be separately connected to the servers 102. There may be more or less than two databases 104, depending on computational and/or distributed computing requirements. The databases 104 may be located at different locations relative to each other and the servers 102.

Each of the clients 106 includes a memory 110, a central processing unit (CPU) 112, an input device 114, and an output device 116. Clients 106 may be a general purpose computer (e.g., a personal computer). Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the clients 106. Clients 106 include one or more applications, program modules, and/or sub-routines. As an example, clients 106 may include a browser application (e.g., Internet Explorer, Firefox, etc.) and a graphical user interface (GUI) to access web sites and web pages provided by the servers 102 and data stored at the databases 104. The system 100 may include more or less than two clients 106. Clients 106 may be remote from each other, the servers 102, and/or the databases 104. Clients 106 may be wireless devices.

The network 108 is a communications network, such as a local area network (LAN), a wide area network (WAN), or the Internet. When the network 108 is a public network, security features (e.g., VPN/SSL secure transport) may be included to ensure authorized access within the system 100.

When a web page includes a number of data items to be presented in a grid layout or a two-dimensional tile format (data items presented in columns and rows configuration), the actual number of data items per row and the number of rows depend upon the size of the active pane of the browser window. Depending on factors such as the type of browser application, amount of tool bars on the browser window, screen resolution, or the user specified size of the browser window (e.g., minimized or maximized view), the size of the window and hence the number of data items (of known fixed pixel size) that will fit within the window varies. To account for these variances, a fluid grid template or layout is implemented.

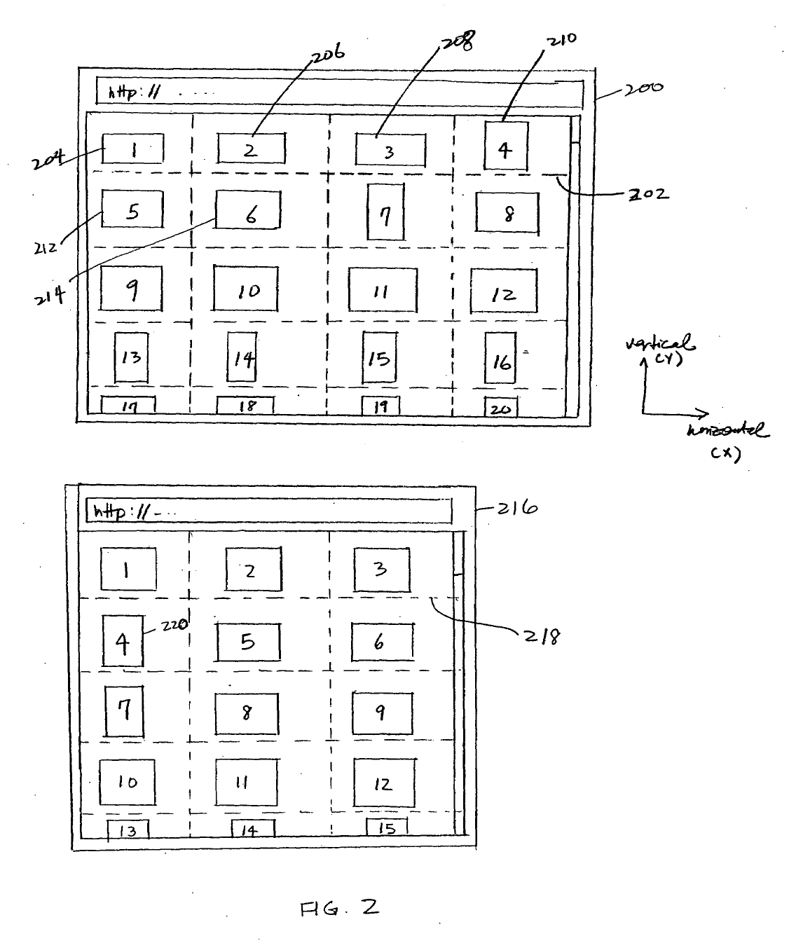

Referring to FIG. 2, different size browser windows are illustrated. In a browser window 200, a grid layout template 202 is implemented to correctly position each of the icons 204, 206, 208, 210, 212, and 214 within the browser window 200. The grid layout template 202 (also referred to as a fluid grid template or layout) is not visible to a viewer of the browser window 200 but is illustrated in FIG. 2 to facilitate discussion of the icon positions. Each of icons 204-214 is representative of an icon or thumbnail of a data item. As an example, the data item can be a digital photo. As another example, the data item can be video file, an audio file, an image file, text, graphics, or other files (e.g., word processing document).

When a web page from the server 102 and/or database 104 is to be displayed at the user's GUI or browser window at the client 106, the pixel size of the icons 2040-214 are known and fixed. The total number of icons to be placed in the grid layout for that web page is also known. The offset or spacing between adjacent icons and the screen resolution of the display device are also known. Hence, based on the user's browser window size, the actual layout of the icons is constructed. The icons 204-214 (also referred to as images) start from the upper left corner and are positioned from left to right - the first image (icon 204), second image (icon 206), third image (icon 208), and fourth image (icon 210) at the first row. Then the fifth image (icon 212) starts the second row.

In contrast, these same icons would be laid out differently if the browser window size is different that the size of the browser window 200. In a browser window 216, which is smaller than the browser window 200, a grid layout template 218 specifies only three images across each row. Thus, the fourth image (icon 210) is located at the second row (see icon 220) instead of at the first row (see icon 210 of browser window 200). Note that in both of the windows 200 and 216, viewing all of the web page requires scrolling down.

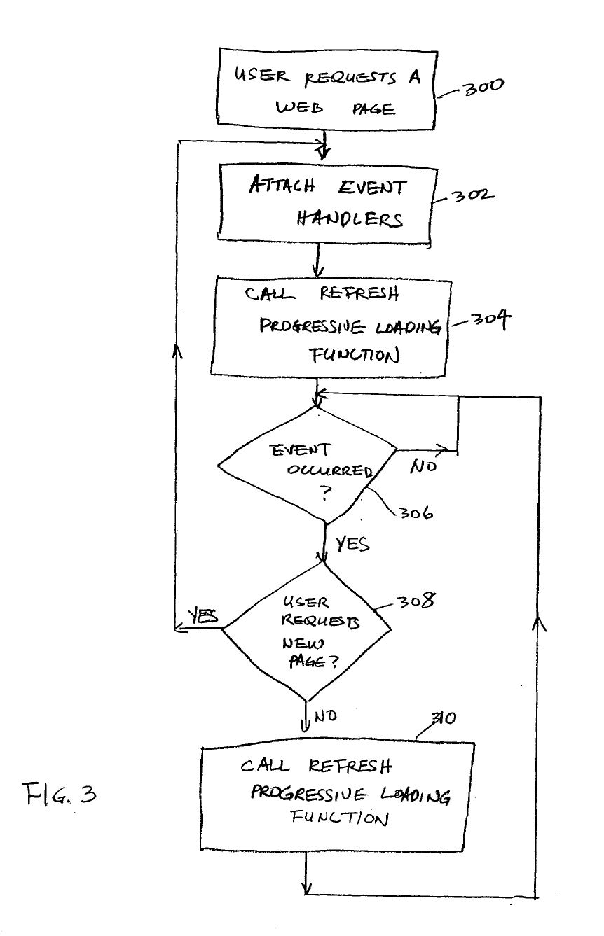

Referring to FIG. 3, a flow diagram illustrating one embodiment of the progressive loading functionality in shown. The flow diagram includes a user requests a web page block 300, an attach event handlers block 302, a call refresh progressive loading function block 304, an even occurred inquiry block 306, a user requests a new web page inquiry block 308, and a call refresh progressive loading function block 310.

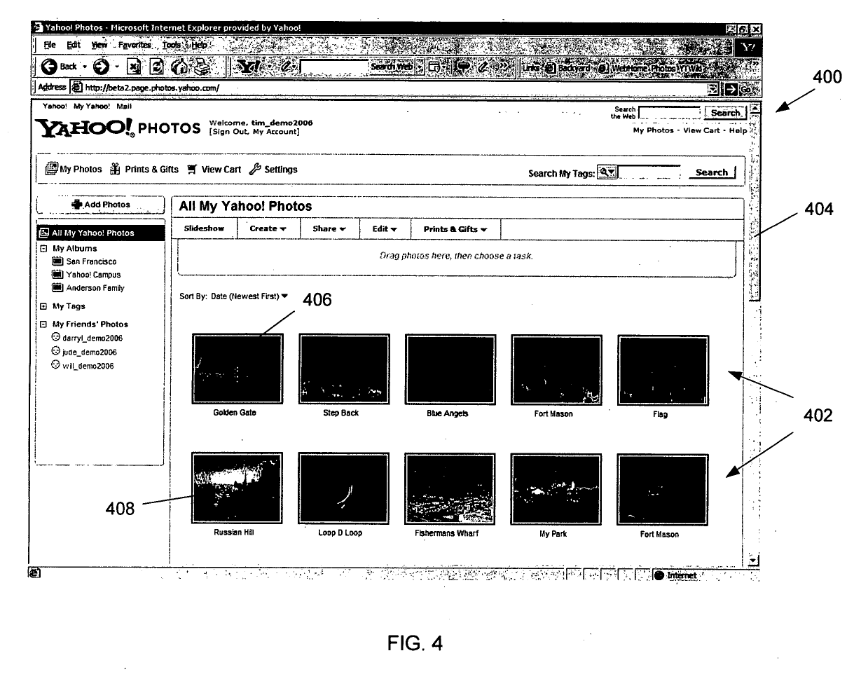

A user assessing the browser application at the clients 106 requests a web site or a web page containing data items to be presented in a grid layout (block 300). The user request can be provided by entering an URL or by clicking a link at an existing web page at the browser window. A screenshot of an example web page including data items to be presented in a grid layout is shown in FIG. 4. In FIG. 4, a browser window 400 shows a web page (e.g., a Yahoo! Photos page) that includes icons or thumbnails 402 of photos in a grid layout. Each of the icons or thumbnails 402 includes a graphical representation of the photo and a name or title associated with the photo.

At the block 302, event handlers attach to the user's browser application to initiate monitoring of the user's actions or behaviors that may relate to progressive loading (also referred to as dynamic, on-demand, or “smart” loading) of data corresponding to select photos. Events, (user actions or behaviors) of relevance include scrolling the web page at the browser, resizing the browser window, or requesting a new web page.

Next at the block 304, a refresh progressive loading function is called. The refresh progressive loading function is provided at the servers 102. The refresh progressive loading function may comprise one or more functions or blocks of code. As an example, the refresh progressive loading function can be implemented in JavaScript or AJAX (asynchronous JavaScript and XML). This function (to be discussed in detail below) comprises determining how many and which photos of the requested web page (continuing the example of FIG. 4) will be viewable in the browser window 400 (the on-screen photos) and requesting that only these on-screen photos be queued and loaded to the browser window from the servers 102 and/or databases 104. In window 400, the on-screen photos (e.g., only photos 1 to 10) have been downloaded and are now viewable by the user. The remaining photos (and icons or thumbnails representative of these photos) in this web page are not queued nor loaded because they cannot be viewed in the present window 400. Pre-loading of the remaining photos in this web page is wasteful of bandwidth since the user may not need them.

Once the photos viewable in the current browser window have been loaded and are presented in the window (e.g., FIG. 4), then the servers 102 monitor for an event occurrence via the event handlers attached to the browser application (block 306). If the event is a user request for a new web page, then the process repeats as discussed above (returns to block 300). If the event is not a user request for a new web page but is one of a scrolling or resizing event, then the refresh progressive loading function is called again (block 310) to determine the appropriate on-screen photos and load those photos to the revised window. The event handlers may monitor for initiation, progress, and completion of an event (e.g., the release of the mouse button).

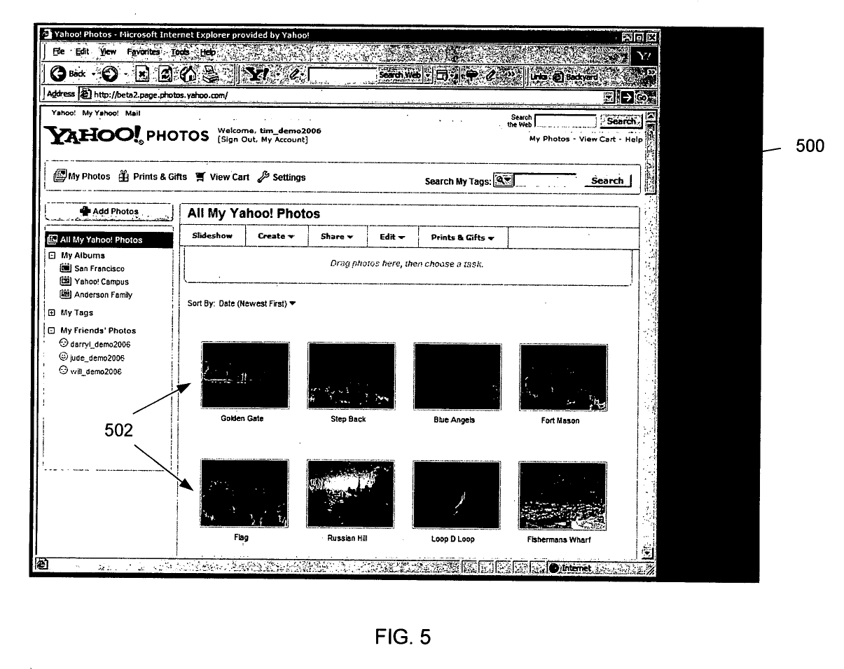

FIG. 5 shows a screenshot after a window resizing event. The window 400 has been reduced in width; the resulting new window 500 is now able to show four icons or thumbnails 502 of the photos per row. The fluid grid layout template (as discussed above) was applied to determine the proper positioning of the icons 502 in the resized window. In this instance, there was no need to queue and load different photos since they had already been loaded when window, 400 was presented. The downloaded photos are cached at the memory 110. In contrast, if the window resizing event had been to increase the width of the window (to for example, accommodate six photos per row), then two additional photos (photos 11 and 12) would have been downloaded from the block 310.

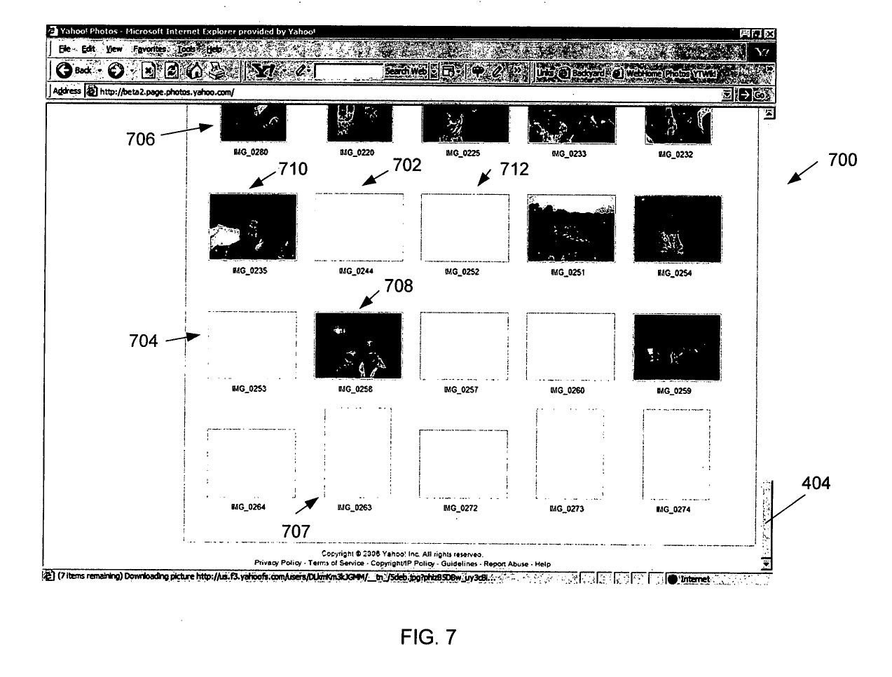

FIG. 7 shows a screenshot after a scrolling event. The user moved a scroll bar 404 down from its top position to its bottom position. The viewable or on-screen photos in the scrolled window (window 700) are different from those in the window 400. The window 400 shows photos at the top of the web page while the window 700 shows photos at the bottom of the same web page. FIG. 7 shows the now viewable photos in the process of loading. These photos had not previously been loaded when the user was viewing the top of the web page (window 400) due to the progressive loading functionality.

Even when a particular photo has not been queued or loaded, the system 100 can provide indicia of the existence, location, and preliminary content of the particular photo. The indicia can be a border (or outline) of the icon or thumbnail in its proper grid location and the title or name associated with that photo. Photos represented by such indicia are also referred to as hidden photos or images. In window 700, examples of hidden photos or images 702, 704, and 707 are-shown. The hidden photos or images may be a pre-cursor to loading of these photos.

The progressive loading function prioritizes responding to relevant events over download completion. Accordingly, if a relevant event occurs during a block in the flow diagram of FIG. 3, for example, during execution of block 304, then the refresh progressive loading function will be called again and the existing queuing and loading activities may be halted. This is because the images currently being downloaded may be irrelevant since the user has moved to a new web page or wishes to view a different portion of the existing web page.

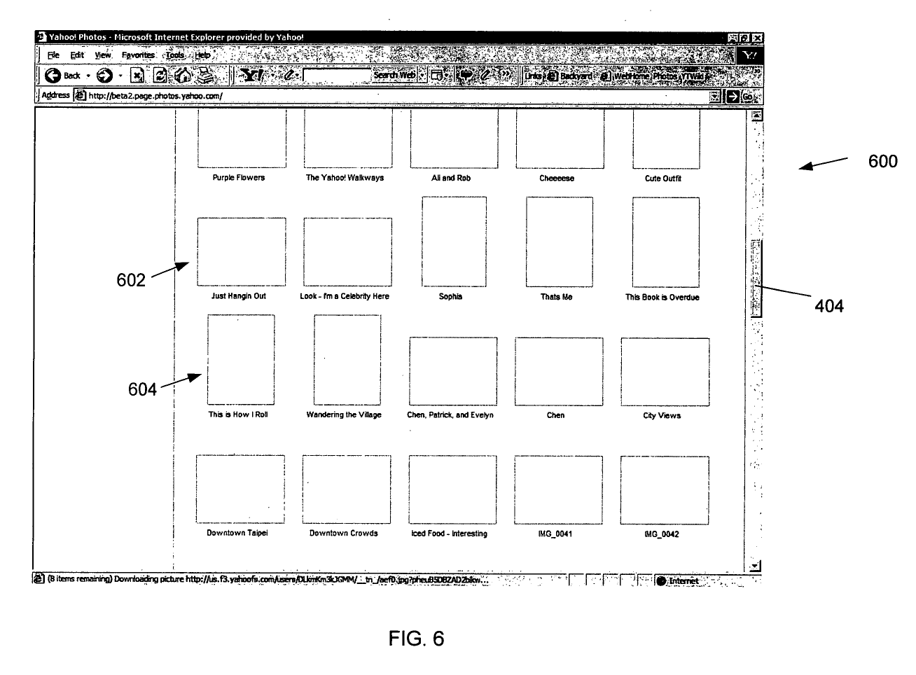

On a related note, if a second event occurs rapidly after a first event, such that there is insufficient time to complete the download request associated with the first event, then the system 100 may not initiate or complete the download request associated with the first event in favor of the second event. An example of this scenario is when the user rapidly scrolls down a web page. The photos in the middle portion of the web page may not be loaded and only hidden photos or images may be shown. When the user activates the scroll bar 404 in the window 400 to quickly scroll down the page, the middle portion of the page shown in a window 600 shows only hidden photos or images 602, 604 (note the scroll bar 404 in FIG. 6 in a lower position than in FIG. 4). When the user completes his scrolling to the end of the page (as shown in FIG. 7), then this event is deemed sufficiently “permanent” to load photos in this portion of the page.

If the user scrolls down slowly or completes scrolling at the position shown in FIG. 6, then these photos would be downloaded instead of being passed-over as described above.

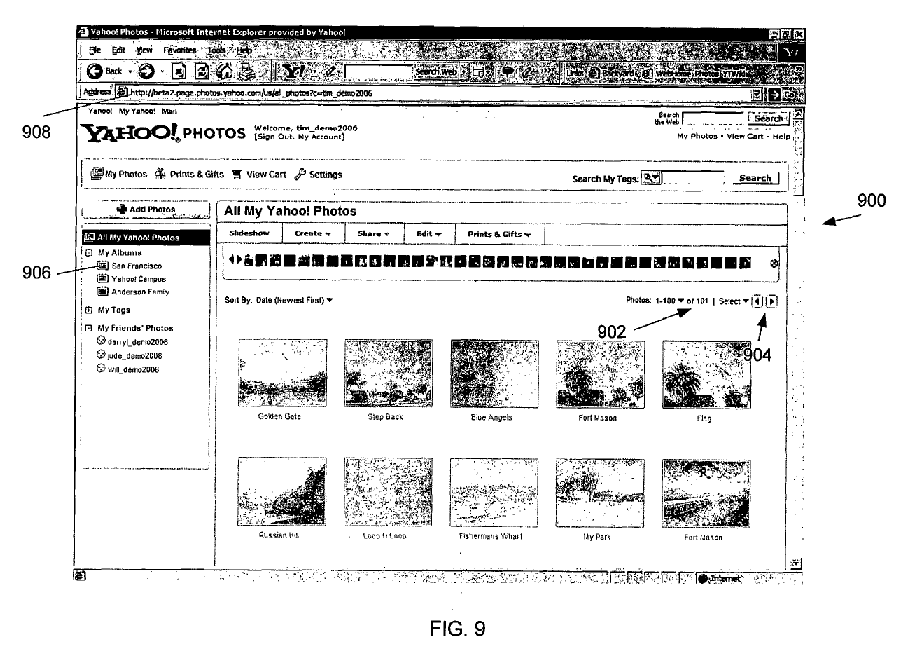

Referring to FIG. 9, a screenshot illustrating possible request for a new page is shown. A web page 900 is another web page including photos presented in a tile or grid layout. The web site associated with the web page 900 provides at most 100 photos per page. The web page 900 includes a count 902 of the total number of photos in the All My Yahoo! Photos bin (or alternatively may be a file folder, category or album). The user has at least three different ways to request a new page. A first option is to click on an arrow 904 to go to the next page of photos in the All My Yahoo! Photos bin. According to the information provided in the web page 900, the next page contains a single photo (photo 101). A second option is to go to another bin or album, such as clicking on the San Francisco album link 906. A third option is to enter an URL in an address field 908 for a different web page including data items to be presented in a grid layout. Examples may be a different on-line photo storage web site, a song purchasing web site where songs are presented in a grid layout, etc.

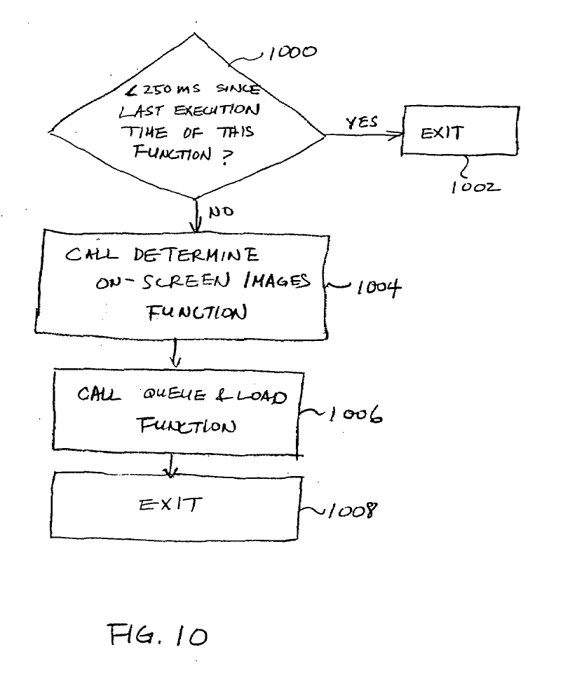

Referring to FIG. 10, one embodiment of a flow diagram illustrating the refresh progressive loading function is shown. The refresh progressive loading function is called by the blocks 302 or 310 in the flow diagram of FIG. 3. The refresh progressive loading function includes an excessive function call check block 1000, an exit block 1002, a call determine on-screen images function block 1004, a call queue and load images function block 1006, and an exit block 1008.

At the block 1000, a check is performed to see if less than 250 millisecond (ms) has elapsed since the last execution time of the refresh progressive loading function. If yes, then the function proceeds to the exit block 1002. This is to retain efficiency and prevent excessive calls to the functions. If at least 250 ms has elapsed, then the determine on-screen images function is called at the block 1004. Upon completion of the block 1004, the queue and load images function is called at the block 1006. Lastly, the function proceeds to the exit block 1008.

It is contemplated that more or less than 250 ms can be used to determine excessive function calls at the block 1000. The time value can be changed based on factors such as equipment, traffic, average image size, or average bandwidth requirements. As an example, the time value can be more than 250 ms if less calls to the functions are desired (perhaps due to limited bandwidth). Or the time value can be less than 250 ms if more responsiveness to user actions is desired. The refresh progressing loading function may also be eliminated and the flow diagram in FIG. 3 may directly call one or both of the determine on-screen images or queue and load images functions.

Referring to FIG. 11, one embodiment of a flow diagram illustrating the determine on-screen images function is shown. The determine on-screen images function is called by the block 1004 in the flow diagram of FIG. 10. The determine on-screen images function includes a calculate vertical position of first image block 1100, a determine number of images per row block 1102, a whether the first row is the sole viewable row inquiry block 1104, an exit and return on-screen indices block 1106, a next row is within viewable window inquiry block 1108, an exit and return on-screen indices block 1110, an end of list inquiry block 1112, and an increment block 1114. The determine on-screen images function is operable to identify the particular images that would be currently viewable in the browser window and are not yet loaded.

At the block 1100, the vertical position of where the first image in the grid layout of the present window would be is calculated. Continuing the example using the screenshot in FIG. 4, the vertical position of an image icon or thumbnail 406 is calculated. This is the leftmost image at the first row (r=1) viewable in the present window. Next, at the block 1102, the number of images per row is determined. The number of images that fit in the first row is counted, which corresponds to the number of images per row in the present window.

If the first row is the only row viewable in the present browser window (block 1104), then proceed to the exit and return viewable indices block 1106. The viewable indices (also referred to as the on-screen list, viewable list, on-screen indices, or viewable image indices) identify the particular images that will fit within the current browser window. Otherwise, there is more than one row of images that will fit within the viewable or on-screen space and continued checking for the last viewable row continues at the block 1108.

In considering whether a row fits within the viewable window, a row in which even a portion of the images would be viewable is considered to be a row that fits within the on-screen space. For example, in FIG. 7, only the bottom portions of the images at a row 706 is visible in the window 700. Nevertheless, the row 706 is considered to be within the viewable window. When the determine on-screen images function is applied to the window 700, the row 706 is considered to be the first row (r=1) for the window 700.

At the block 1108, the vertical position of the first image at the second row (r=2) of the present window is checked for viewability. To identify the vertical position of the first image in the respective row, values such as the vertical size of the first image, the vertical offset (or spacing) of the first image from the window edge, the window height, and the vertical offset (or spacing) from the row above are taken into account. Continuing the example using FIG. 4, the first image at the second row is an image 408.

If the first image at the second row does not fit within the window (i.e., no portion of the first image at the second row would be visible in the window), then proceed to exit and return viewable image indices in the block 1110. Otherwise, the first image at the second row would fit within the window. At the block 112, a check is performed to see if the last image for that web page is at the second row (an end of list or indices check). If the end of list or indices has been reached, then there would be no more images for that page and the viewable image indices is now known (block 1110).

Otherwise, the row check continues by incrementing r by 1 (r=r+1) and then checking the first image at the next row (e.g., r=3) at the block 1108. This looping continues till either the end of list is reached or the row where the images are completely outside of the browser window (off-screen) is identified.

In identifying the viewable image indices to return to the refresh progressive loading function, the determine on-screen images function takes into account images that have already loaded to the browser window. This can occur, for example, when images were previously on-screen (from a previous user request) so they have previously loaded. Hence, the viewable image indices identify the particular images that are viewable within the window and which have not loaded. Continuing the example using FIG. 4 and assuming that the user requested the web page shown in the window 400 for the first time, the viewable image indices or list would be images 1-10. Images 11, 12, etc. would not fit within the window 400. In contrast, if the user had previously requested the portion of the web page starting with the image 408, then images 6-10 would have loaded and cached with that previous request. Thus, when the user later requests the portion of the web page shown in the window 400, the viewable image indices would only be images 1-5.

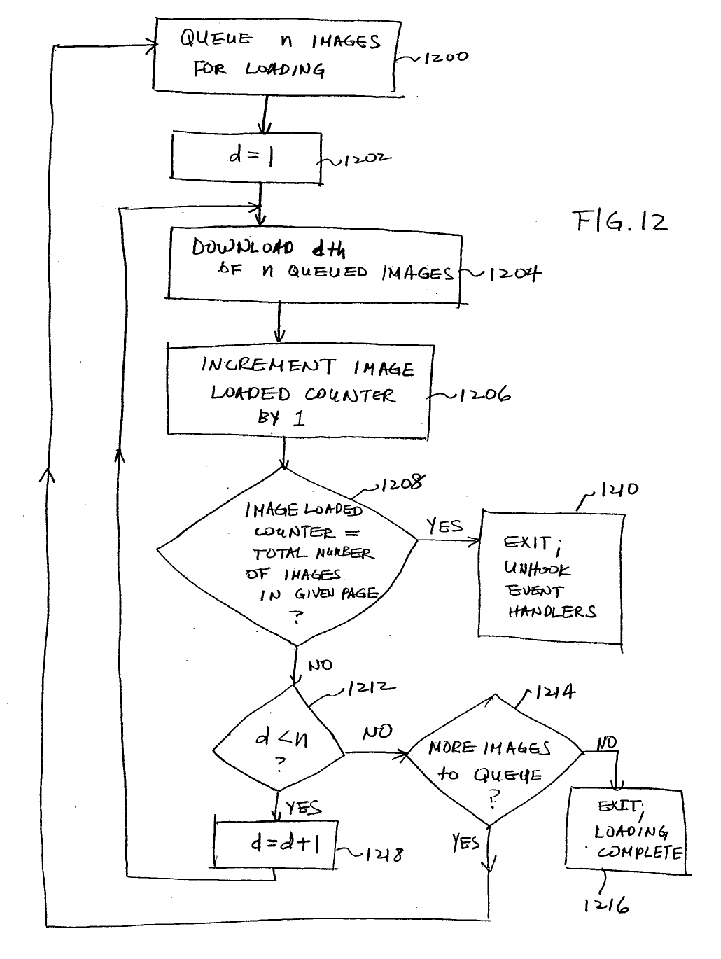

With the particular images to be loaded identified, queuing and loading of these images can take place. Referring to FIG. 12, one embodiment of a flow diagram illustrating the queue and load function is shown. The queue and load function includes a queue images block 1200, a starting download incrementor block 1202, a download block 1204, an increase image loaded counter block 1206, a end of list check 1208, an exit and unhook event handler block 1210, a check for downloading completion of the queued images block 1212, a check for additional queuing block 1214, an exit and loading complete block 1216, and a download increment block 1218.

At the block 1200, an n number of images identified in the viewable indices are queued for loading. The variable n is typically set at a constant number to balance loading of maximum number of applicable images in the minimum amount of time, likely number of applicable images to be loaded, and likely fully use of available bandwidth while downloading. In one embodiment, n=8 and eight images are queued simultaneously. However, the variable n is a default value and the block 1200 has the capability to set n at less than eight images if there are fewer than eight images that need to be loaded. For example, in the window 400, the first queue would be for images 1-8 (thus, n=8) and then the second queue would be for images 9-10 (thus, n=2). It is contemplated that the default value for n can be greater or less than eight.

After the appropriate number of images have been queued for loading (e.g., the first queue), these queued images are loaded with little or no wait time between loadings. At the block 1202, the download incrementor is set for the first download (d=1). Next, the first image of the queued images is downloaded (block 1204). Upon completion of the download of the first image, an image loaded counter is incremented by one (block 1206).

Next a check is performed to see if the image loaded counter equals the total number of images for the given page at the block 1208. If yes, then proceed to the exit and unhook event handlers block 1210. Since all the images for the given page have loaded (during current call to the queue and load function and/or from previous call(s) to the queue and load function), there are no more images to load for that page. Additionally, no event associated with the page would require loading of images for that page and thus the event handlers can be disassociated from the browser application. Unhooking the event handlers from the browser application prevents unnecessary use of resources of the browser, progressive loading function, and/or the servers 102.

On the other hand, if the image loaded counter is less than the total number of images for the given page, then a check is performed to see if all the currently queued images have been downloaded (block 1212). If all the currently queued images have been downloaded, then there may be additional images to be queued (block 1214). If there are no more images to queue, then the function exits since the loading is complete (block 1216). When there are additional images to queue (for example, the second queue of images 9-10 in the window 400), then the function returns to the queuing block 1200 to queue and load the next set of images.

If less than all of the currently queued images have downloaded, then the download counter increments by one (d=d+1) at the block 1218 and the next queued image is downloaded (returns to the block 1204). This looping continues till completed loading of all the images in the current queue occurs.

Accordingly, a “page” of items is constructed or built on-demand (also referred to as as-needed, on-the-fly, dynamically, or progressively) based on the user's actual behavior. There may be one or more “pages” in a given view. In particular, only the portion of the web page that can actually be viewed by the user at the user's browser active window or GUI is constructed. Then by monitoring the user's subsequent behavior relating to that web page, on-demand construction of another portion or rest of the web page occurs. All data items (also referred to as objects, elements, data, or content) for the given page are retrieved and created as a grid layout within the browser and are used to construct the corresponding portion of the web page, but the related images are only loaded on an “as-needed” basis. The remainder of the data items (those data items on other “pages”) are not queued or loaded even though the user has requested the web page. Of course, the remainder of the data items are loaded and presented to the user if the user so specifies by manipulation of the GUI.

Referring to FIGS. 4 and 6-8, an example of progressive loading of images in a grid layout of a web page is illustrated. FIG. 4 is representative of the initial view of the web page requested by the user after completion of progressive loading for that portion of the web page. The window 400 shows images 1-10 laid out in two rows 402, images 1-5 comprising the first row and images 6-10 comprising the second row. At this point in time, all images starting from image 11 that would be presented in the column and row configuration have not been queued nor loaded, since they cannot be seen by the user in the window 400 (e.g., at the top of the web page).

Next, the user activates the scroll bar 404 and rapidly moves it downward. The user rapidly scrolls downward on the same web page shown in the window 400, but there is insufficient time for the newly on-screen images to load and be viewed by the user before becoming off-screen. For this reason, only hidden images or indicia (e.g., hidden images 602, 604) are provided to indicate the existence of newly on-screen images in the window 600. It is noted that if the user were to slowly scroll down the web page or stop scrolling at the portion of the web page shown in the window 600, the newly on-screen images would load and be fully presented.

FIG. 7 illustrates the bottom portion of the same web page of windows 400 and 600. Since the user has completed the scrolling action, the progressive loading function calls the determine function and queue and load function to download the images viewable in this bottom portion of the web page. The window 700 illustrates the images in the process of downloading. The downloading in one embodiment occurs in a scattered fashion (e.g., image 708 loading before image 702, even though image 702 has a smaller index). In another embodiment, the downloading occurs on order (e.g., image 710 downloads before image 702, and image 702 downloads before image 712).

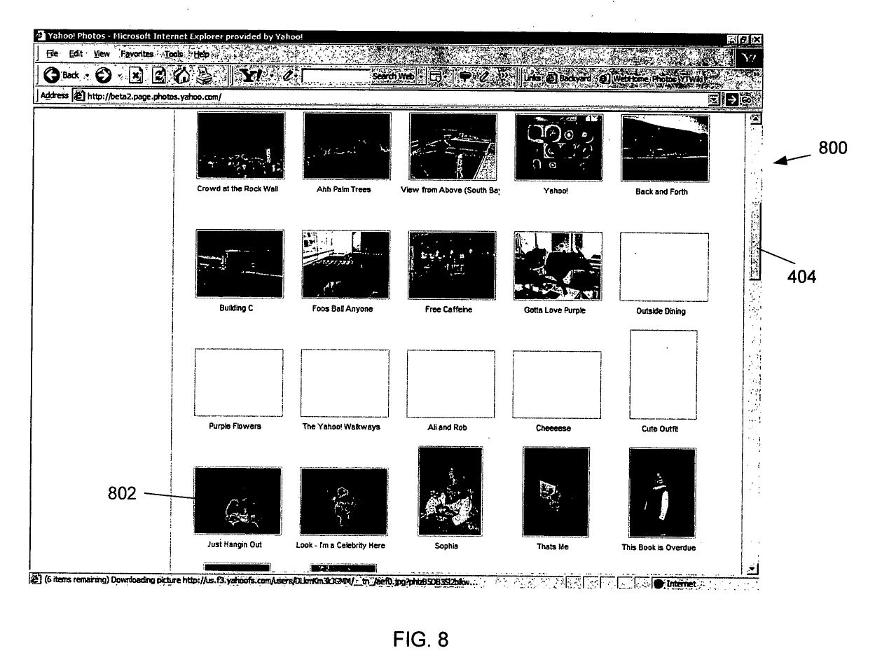

Lastly, when the user scrolls up to return to the mid section of the web page, the images in this section of the web page are now loaded since user's scroll behavior indicates actual viewing interest of this section of the web page. FIG. 8 is a screenshot after the user has scrolled back up from the window 700 and loading is in progress. Notice that, for example, the hidden image 602 in the window 600 has now loaded and is an image 802 in a window 800.

It is understood that loading or downloading an image (or generally, a data item) refers to obtaining the data associated with that image such that the image is fully accessible. This is the case even if only an icon or thumbnail of the image is visible on the web page. If the user clicked on any icon of a image in FIGS. 4-9, the image appears in full size and resolution. Downloading an image generally refers to transmitting the data associated with the image from the servers 102 and/or databases 104 to at least one of the clients 106 via the network 108. Loading an image can include downloading the image and/or receiving the data at at least one of the clients 106.

In this manner, a system and method for providing progressive loading of data items positioned in accordance with a grid template in a web page are disclosed herein. The progressive loading function only loads those data items that are within the active window of the user's browser GUI. Additional data items that are hidden from the user (because they are positioned at a different portion of the web page not visible in the current window) are not pulled from the servers 102 and/or databases 104. When the user generates an action that requires other or additional data items to be within the current window, then the progressive loading function pulls/loads these data items. This scheme minimizes the initial load time of the page, which enhances the user's experience. This scheme also monitors and provides results in direct response to user's actual behavior.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The invention can be implemented in any suitable form including hardware, software, firmware or any combination thereof. Different aspects of the invention may be implemented at least partly as computer software or firmware running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for progressively constructing a web page, the method comprising:
determining the portion of the web page viewable at a user-interface (UI) window, wherein the determined portion of the web page comprises a first portion of the web page;
identifying data items that will be at least partially viewable within the first portion of the web page, wherein the data items are to be positioned within the first portion of the web page in accordance with a grid template;
loading the identified data items; and
providing the first portion of the web page at the UI window using the loaded data items, wherein data items associated with the portion of the web page not presently viewable at the UI window are not loaded.

2. The method of claim 1, further comprising:
determining previously loaded data items from the identified data items, and
excluding the previously loaded data items from queuing and loading.

3. The method of claim 1, further comprising monitoring for a request for a different web page, wherein the different web page includes data items positioned in accordance with an another grid template.

4. The method of claim 3, further comprising repeating determining the portion of the web page, identifying data items, queuing the identified data items, loading the identified data items, and providing the first portion of the web page with respect to the different web page, in response to the request for the different web page.

5. The method of claim 1, further comprising monitoring for a request for a second portion of the web page, wherein the first and second portions are different portions of the web page.

6. The method of claim 5, wherein the request for the second portion of the web page comprises scrolling to the second portion of the web page.

7. The method of claim 5, wherein the request for the second portion of the web page comprises changing a viewable size of the UI window.

8. The method of claim 5, further comprising repeating determining the portion of the web page, identifying data items, queuing the identified data items, loading the identified data items, and providing the first portion of the web page with respect to the second portion of the web page, in response to the request for the second portion of the web page.

9. The method of claim 1, wherein providing the first portion of the web page in progress is halted when an event occurs to no longer make the first portion of the web page viewable at the UI window.

10. The method of claim 1, wherein the data items are selected from a group consisting of text, image, graphics, audio, files, multi-media content, icons, advertisements, and thumbnails.

11. The method of claim 1, wherein the data items comprise thumbnails of digital photos.

12. The method of claim 1, wherein loading the identified data items comprises loading a portion of the data associated with each of the identified data items, and providing the first portion of the web page comprises providing the first portion of the web page at the UI window using the portion of the data associated with each of the identified data items.

13. A computer program product comprising computer-executable code for dynamically loading elements to a client device, the computer program product comprising code for:
tracking which elements included in a page will be visible at the client device, wherein the page includes a plurality of elements positioned in accordance with a grid layout; and
dynamically loading the tracked elements for presentation at the client device, wherein the elements that will not be visible at the client device are not loaded.

14. The computer program product of claim 13, wherein dynamically loading the tracked elements comprises not loading the elements previously loaded in a current session of the client device.

15. The computer program product of claim 13, further comprising:
monitoring an event occurrence at the client device that changes which elements included in the page will be visible.

16. The computer program product of claim 15, wherein the event occurrence is selected from a group consisting of a scroll event and a resize event.

17. The computer program product of claim 13, further comprising:
monitoring an event occurrence at the client device that requests a new page; and
calling the code operable to track and dynamically load with respect to elements included in the new page that will be visible at the client device.

18. The computer program product of claim 13, wherein the tracked elements is selected from a group consisting of text, image, graphics, audio, files, multi-media content, icons, advertisements, and thumbnails.

19. An apparatus for constructing a partial page on an as-needed basis comprising logic operable to:
determine first objects that will be at least partially positioned within a first viewable segment of a page, wherein the first viewable segment of the page comprises a segment of the page that is currently requested at a client site;
download the first objects to present the first viewable segment of the page at the client site, wherein at least one of the first objects is positioned within the first viewable segment of the page in accordance with a grid layout; and
download second objects that will be at least partially positioned within a second viewable segment of the page when the segment of the page that is currently requested changes from the first viewable segment of the page to the second viewable segment of the page, wherein the first and second viewable segments of the page comprise different segments of the page relative to each other, and at least one of the first and second objects comprises different objects relative to each other.

20. The apparatus of claim 19, further comprising logic operable to attach event handlers to the client site to monitor the request change from the second viewable segment of the page to a third viewable segment of the page.

21. The apparatus of claim 19, further comprising logic operable to attach event handlers to the client site to monitor a request for a different page, wherein the different page includes objects positioned in accordance with the grid layout.

22. The apparatus of claim 19, further comprising logic operable to:
attach event handlers to the client site to monitor further request changes; and
detach the event handlers from the client site when all the objects within the page have been downloaded.

23. The apparatus of claim 19, wherein the first and second objects is selected from a group consisting of text, image, graphics, audio, files, multi-media content, icons, advertisements, and thumbnails.

24. The apparatus of claim 19, wherein the first and second objects comprise thumbnails of digital photos and the page comprises a web page.

25. A server system in communication with a plurality of clients, the server system comprising logic operable to:
receive a first request for a page from a client;
load at least a first data item included in the page that will be at least partially visible within a viewing window of the page at the client;
provide the page including the loaded first data item to the client; and
wait to load at least a second data item included in the page, the second data item positioned outside the viewing window of the page at the client, until a second request from the client requests the second data item be at least partially visible within the viewing window of the page at the client,
wherein data items included in the page are positioned according to a dynamic grid template and the data items include the first and second data items.

26. The server system of claim 25, wherein the data items are selected from the group consisting of text, image, graphics, audio, files, multi-media content, icons, advertisements, and thumbnails.
